(19) United States
(12) Patent Application Publication
(10) Pub. No.: US 2009/0254209 A1
(43) Pub. Date: Oct. 8, 2009

(54) PATH MAPPING METHOD AFTER OPTICAL DEFECT DETECTION

(75) Inventors: Sze Yeong Tan, Taipei City (TW); Jia-Lin Shen, Taipei City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: DELTA ELECTRONICS, INC., Taoyuan Hsien (TW)

(21) Appl. No.: 12/406,988

(22) Filed: Mar. 19, 2009

(30) Foreign Application Priority Data
Apr. 8, 2008 (TW) 097112717

(51) Int. Cl. G06F 17/00

(52) U.S. Cl. 700/110

(57) ABSTRACT

A path mapping method after an optical defect detection is provided. The path mapping method after an optical defect detection includes steps of providing an article, detecting at least two defects on the article, providing a numerical operation model and obtaining a mapped path for connecting the at least two defects by using the numerical operation model.

### FIELD OF THE INVENTION

The present invention relates to a path mapping method after an optical defect detection, and more particularly to a path mapping method for the optical defect detection, inspection and repairing by the optical instruments.

### BACKGROUND OF THE INVENTION

For the product with a tabular or planar shape, the automated optical inspection system is the machine most often used in the yield rate inspection. The system includes the defect detection, defect inspection and defect repairing machines, the database and the display device. The defect detection machine linearly scans the article to create the image of the article, and after then the image is analyzed by using the image processing technique to find out the defect locations (usually the coordinate information), which is then saved in the database. Afterwards, the defect inspection machine moves to the location of each defect, and the defects are manually inspected. The detail tiny structures of the defects can be more clearly inspected through the high-resolution optical devices of the defect inspection machine. Furthermore, the image file for the individual defect can be saved so that the officials in the Quality Assurance Department can analyze the cause of the defects and can determine whether the defects can be fixed or not and the fixing method. After inspecting the defects, the defect repairing machine moves to the locations of the defects to repair the defects.

Please refer to FIG. 1, which is a schematic diagram showing the operation of the prior-art automated optical detection system. In FIG. 1, the defect detection machine contains an image capturing device 2, the defect inspection machine contains an inspection device 3, and the defect repairing machine contains a repairing device 4. Generally, the detection device 3 and the repairing device 4 are included in the same optical inspection and repairing machine (not disclosed in FIG. 1). When the defect detection machine is operated, the detected article 1 is scanned from the top portion of FIG. 1 to the bottom portion of FIG. 1 by the image capturing device 2 (a linear scanning CCD). After scanning, the scanned image is processed by the defect detection machine to obtain the first defect X1 to the eighth defect X8, for example, as shown in FIG. 1. The sequence order for these defects is generated because of the defect detection machine, as one kind of scanner. The sequence order for the coordinate of each point of the scanned article is arranged by starting at the topmost row from the left to the right in the same row and then moving row-to-row from the top to the bottom with the same scanning direction from the left to the right in each row. Therefore, these defects are labeled from X1 to X8 as shown in FIG. 1.

Please continue to refer to FIG. 1, after all defects are detected, then each defect is inspected. In the current technique, the inspection of the defects follows the sequence order defined by defect detection machine, i.e. from the left to the right in the same row and then moving row-to-row from the top to the bottom with the same scanning direction from the left to the right in each row. Thus, each defect is inspected by the inspection device 3 according to the order, from the first defect X1 to the last defect, eighth defect X8. The same sequence order will be followed by the defect repairing device 4. The first path P1 is formed by connecting each defect from the first defect X1 to the eighth defect X8.

However, when each defect is detected, inspected and repaired according to the first path P1 with the order from the first defect X1 to the eighth defect X8, the moving distances for the inspection device 3 and repairing device 4 will be too long. Since both the inspection device 3 and repairing device 4 are large and precision instruments, it is almost impossible to reach both the high moving speed and precision positioning at the same time. In order to reach both the high moving speed and precision positioning at the same time, the dimensions for these two devices must become much larger and the cost must become much higher as well. Therefore, in the current technique, the moving speeds of the inspection device 3 and repairing device 4 are quite slow. It takes very long time to complete the first path P1 in FIG. 1.

As described above, when the path for the inspection and repairing is long, the whole processing time for the inspection and repairing will be elongated, and this will increase the cost for the products with the inspected article 1. Finally, the production yield can not be raised. Therefore, how to accelerate the optical inspection process becomes a very important issue.

In order to solve the above-mentioned problems, the new concepts and the solutions are proposed in the present invention in order to shorten the optical inspection and repairing process time by using the much more effective and efficient methods. The present invention is described below.

### SUMMARY OF THE INVENTION

The present invention provides a path mapping method for the optical defect inspection and repair.

In accordance with one aspect of the present invention, a path mapping method after an optical defect detection is provided. The path mapping method after an optical defect detection includes steps of providing an article, detecting at least two defects on the article, providing a numerical operation model, and obtaining a mapped path for connecting the at least two defects by using the numerical operation model.

Preferably, the mapped path is one of a shortest path and a preferable path for connecting the at least two defects.

Preferably, the at least two defects are detected by scanning the article by using an optical detection machine.

Preferably, a path mapping method further comprises a step of providing the mapped path for an operation of one of a defect inspection machine, a defect repairing machine and a combination thereof, wherein the mapped path is an open path with two ends, and the one of the defect inspection machine, the defect repairing machine and the combination thereof operates along the open path by starting at one of the two ends.

Preferably, a path mapping method further comprises a step of storing data of the at least two defects and the mapped path in a database.

In accordance with another aspect of the present invention, a path mapping method after an optical defect detection is provided, where at least two defects on an article are detected after scanning the article by using an optical detection machine. The path mapping method comprises steps of generating at least one sequence of the at least two defects, obtaining at least one path for connecting the at least two defects according to the at least one sequence, comparing the at least one path, and choosing a desired path from the at least one path.

Preferably, the desired path is a shortest path among the at least one path.

Preferably, the desired path is provided for an operation of one of a defect inspection machine, a defect repairing machine and a combination thereof.

Preferably, the desired path is an open path with two ends, and the one of the defect inspection machine, the defect repairing machine and the combination thereof operates along the open path by starting at one of the two ends.

In accordance with a further aspect of the present invention, a path mapping method after a defect detection is provided. The path mapping method comprises a step of determining a mapped path for connecting a plurality of defects by using a numerical operation model.

Preferably, the mapped path is one of a shortest path and a preferable path for connecting the plurality of defects.

Preferably, the path mapping method further comprises a step of providing the mapped path for an operation of one of a defect inspection machine, a defect repairing machine and a combination thereof.

Preferably, the mapped path is an open path with two ends, and the one of the defect inspection machine, the defect repairing machine and the combination thereof operates along the open path by starting at one of the two ends.

Preferably, the starting end is a nearer end to the one of the defect inspection machine, the defect repairing machine and the combination thereof.

Preferably, the defect inspection machine comprises a photosensitive unit being one of a charge coupled device and a complementary metal-oxide semiconductor.

Preferably, the path mapping method further comprises a step of storing data of the plurality of defects and the mapped path in a database.

Preferably, the numerical operation model is one selected from a group consisting of a brute force method, a cutting plane method, a Markov chain method, a nearest neighborhood method, a generic algorithm and an ant colony optimization algorithm.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is the schematic diagram showing the operation of the prior-art automated optical detection system;

FIG. 2 is the schematic diagram showing the operation of the automated optical detection system according to the present invention; and

FIG. 3 is the schematic diagram showing the flow chart for the operations of the inspection device and the repairing device according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

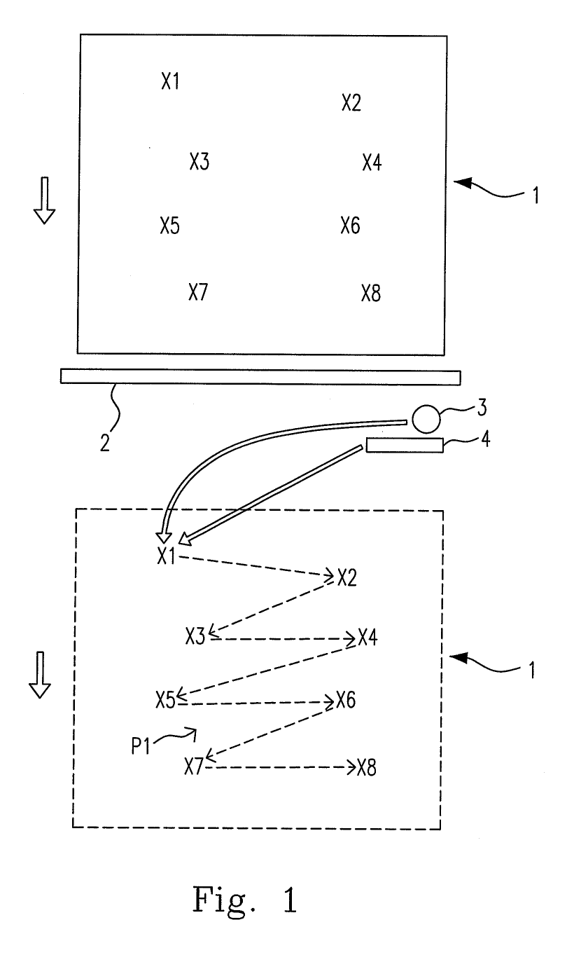

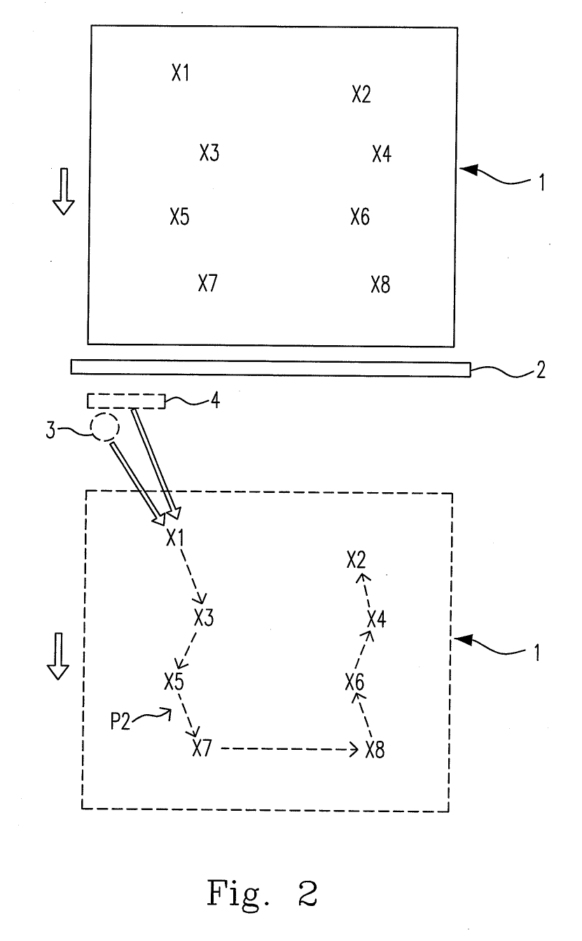

Please refer to FIG. 2, which is the schematic diagram showing the operation of the automated optical detection system according to the present invention. In FIG. 2, the defect detection machine contains an image capturing device 2, the defect inspection machine contains inspection device 3, and the defect repairing machine contains a repairing device 4. Generally, the detection device 3 and the repairing device 4 are included in the same optical inspection and repairing machine (not disclosed in FIG. 2). Since the defects must be found first, and then each defect can be individually inspected and repaired. The practical step to find the defects is using the defect detection machine to scan the detected article 1. Usually the image capturing device 2 is kept standstill, while the detected article 1 is moving. Of course, the detection process can also work by the reverse way. That is, the detected article 1 is kept standstill, while the image capturing device 2 is moving. It depends on the practical operation to choose the way for the detection process, but there is the relative motion between the image capturing device 2 and the detected article 1 for both ways. In this technical field, since the detection machine is integrated into the production line, thus usually the image capturing device 2 is remained standstill, while the detected article 1 is moving. After the defect detection, the image of scanning the detected article 1 is processed to find out the defects, which are named as first defect X1 to eighth defect X8 as shown in FIG. 1. In the present invention, the defect information can be stored in a database. Please continue to refer to FIG. 2. Since the first defect X1 is the first defect detected by the defect detection machine, and usually is set as the starting point for the movements of the inspection device 3 and the repairing device 4. That is, the first defect X1 is the first defect to be inspected and repaired. On the other hand, the nearest defect to the inspection device 3 and the repairing device 4 can be set as the starting point for the moving paths for these two devices certainly. For the optical system, the above-mentioned devices usually follow the moving way of “left to right, up to down”. Therefore, the defect inspection device 3 and defect repairing device 4 are initially located in the left top corner of the detected article 1, and are denoted in dash lines in FIG. 2. Accordingly, the first defect X1 is a starting point of the moving paths for the respective devices.

Since the defect inspection device 3 and defect repairing device 4 are precision instruments with heavy weight, their moving speed are relatively slow. In order to avoid the elongated processing time for the defect inspection and repairing due to the too long path in the current technique, the numerical operation model is provided in one of the steps of the present inventive method to obtain a path for connecting all defects. This path is the shortest or the preferable path for connecting all defects, is not a closed loop, and can be provided for the operations of the defect inspection or repairing machines. In addition, this path can be saved in a database.

Certainly, there are various numerical operation models, from which different paths with the same or different lengths can be generated. Thus, the present invention introduces the steps of calculating and comparing the lengths of the paths generated from various numerical operation models to find out the shortest path as the moving paths for the defect inspection device 3 and defect repairing device 4. Basically, it is fine to use only one numerical operation model. However, only one numerical operation model may not guarantee to obtain the shortest path under any defect distribution condition. Since the information technologies are advanced nowadays, two or more numerical operation models may be used to obtain two or more paths, which are compared to choose the shortest one. As the above-mentioned, using the shortest path determined by the present invention can greatly reduce the whole processing time for optical inspection and repairing, increase the production yield, alleviate the machine wearing, and extend the machine lifetime. In other words, the above-mentioned machines by using the shortest path in the present invention can quickly move to the locations of the defects, and thus more defects can be detected and repaired by the defect inspection device 3 and defect repairing device 4 during the same period of time.

Please refer to FIG. 2 again. The shortest path for connecting all defects with the starting point at first defect X1 is obtained and shown in FIG. 2. The sequence order is listed in the followings, first defect X1, third defect X3, fifth defect X5, seventh defect X7, eighth defect X8, sixth defect X6, fourth defect X4 and second defect X2 as the end point. Certainly, the path can be manually determined as well. However, the manual determination may be only available to simple cases due to the limitation of manual estimations and human attentions. Therefore, the path is determined by using the above-mentioned numerical operation models in the present invention. Several numerical models can be selected, e.g. brute force method, cutting plane method, Markov chain method, nearest neighborhood method, generic algorithm, and ant colony optimization algorithm.

In the brute force method, all possible paths are listed, and the length for each path is calculated. Finally, the lengths of all paths are compared, and the shortest one is chosen. Then the shortest path is used as the moving path for the defect inspection and repairing devices in order to shorten the moving distances and save the processing time. Using the path mapping method of the present invention described above for the automated optical inspection and repairing machines can greatly increase the production rate with the high efficiency.

Please refer to FIG. 2. It needs to be aware that the shortest path proposed in the present invention is provided to be used by the defect inspection device 3 and defect repairing device 4, so the locations of these two devices may be taken into account. As shown in FIG. 2, the initial locations of these two devices denoted as dash lines can be treated as the points in the path. These initial locations are usually the starting points. In FIG. 2, the first defect X1 is coincidentally the nearest point to the defect inspection device 3 and defect repairing device 4, the second point in the path, and is the first defect reached by these two devices. Since the path is provided to be used by the defect inspection device 3 and defect repairing device 4, the locations of these two devices can be joined with those of all defects together for the calculation by using at least one of the numerical operation models so as to obtain a path. In such a condition, one more point is added into the calculation with or without the restriction of defining the locations of these two devices as the starting points. The path determined only by the locations of the defects can be called the first path with two ends. While the locations of the defect inspection device 3 and defect repairing device 4 are further taken into account, one of the two ends closer to the location of one of these two devices can be connected therebetween to obtain the second path.

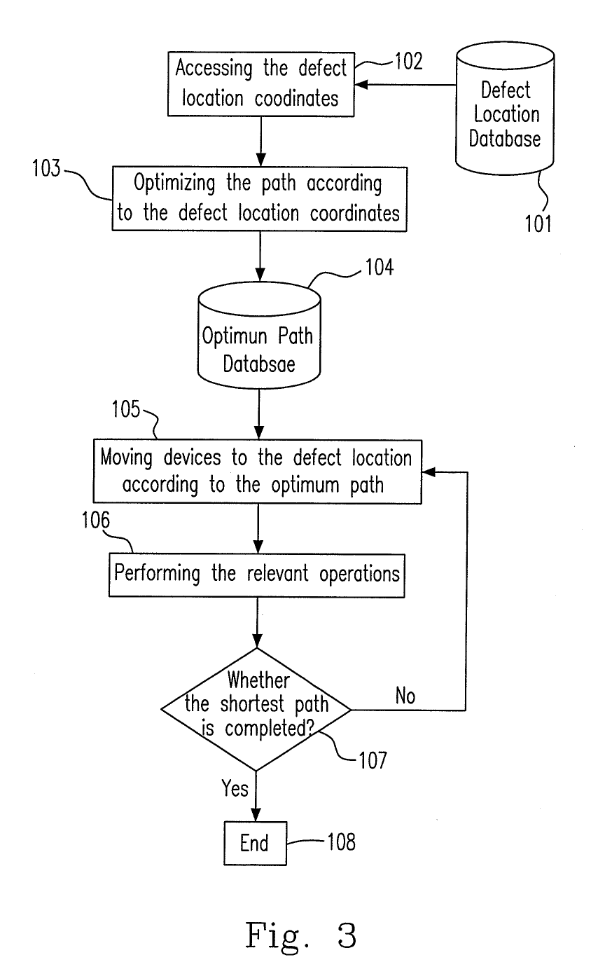

Please refer to FIG. 3, which is the schematic diagram showing the flow chart for the operations of the inspection device and the repairing device according to the present invention. At first, the image capturing device 2 of the defect detection machine scans a detected article. The scanned image is processed to find out the locations of the defects, which coordinates are stored in a defect location database 101. Then, in the step 102, the defect location coordinates are accessed usually by the controller of the automated optical detection system. In the step 103, the path is optimized according to the defect location coordinates. In the present invention, the numerical operation models are utilized, and the optimization is executed by finding the shortest path for the defect inspection device 3 and defect repairing device 4 to go through all the defects. Please refer to FIG. 2 at the same time. Then the obtained optimum path is stored in the optimum path database 104. Actually, the existing database in the automated optical detection system can be partitioned into some available storage spaces, one of which can be used as the optimum path database 104. In the step 105, the defect inspection device 3 and defect repairing device 4 are moved to the defect locations according to the sequence determined in the optimum path. The optimum path can be determined by taking the locations of the defect inspection device 3 and defect repairing device 4 into account. In the step 106, the relevant operations proceed, where the relevant operation for the defect inspection device 3 is the detail and precise inspection on the individual defect; while the relevant operation for the defect repairing device 4 is the repairing on the defects. The defect inspection device 3 can create defect image database, which can be provided for the analyses of the causes of the defects by the officials in the Quality Assurance Department as the reference to improve the production processes. When the relevant operation for a defect is finished by the defect inspection device 3 and defect repairing device 4, it is checked in the step 107 whether the shortest path is completed or not. If not, the device will move to the next defect in the mapped optimum path. If the shortest path is completed, then the whole process is ended in the step 108. When the command of ending is executed, the device may stay right there or return to its initial location according to the setting, which may be changed by the user for the practical requirements.

One of the methods to determine the shortest path for at least two defects in the present invention includes the following steps. In the step (1), the defects are arranged by the permutation to generate at least one sequence order. In the step (2), at least one path is obtained by connecting the defects according to the sequence order generated in the step (1). In the step (3), the paths obtained in the step (2) are compared, and the shortest path is reserved. The comparison of the lengths of the paths and the selection of the shortest path in the step (3) are just the example of using the brute force method as a numerical model in the present invention.

Usually, the desired path is chosen, and in the most conditions, the desired path is the shortest path. Therefore, generally when the paths are obtained, then the lengths of the paths are compared, and only the shortest path is reserved as the moving path for the defect inspection device 3 and defect repairing device 4.

In addition to the brute force method, several other numerical operation mode Is are available, including cutting p lane method, Markov chain method, nearest neighborhood method, generic algorithm, and ant colony optimization algorithm. If the calculation capacity of the machine can afford, two or more numerical operation models can be utilized simultaneously, and the respective shortest paths from these numerical operation models can be further compared to obtain the shortest path among them.

The above-mentioned defect inspection device is usually an electronic camera device or system, which contains a photo-sensitive component made by a charge coupled device (CCD) or a complementary metal-oxide semiconductor (CMOS). The defect repairing device is usually used to remove the redundant materials and foreign particles, and to fill the required materials, while the redundant materials and foreign particles result in the defects. The removing method includes using a laser, a focused ion beam, an electron beam, etc. The purpose of filling the required materials is to fill the suitable materials into the defects where the material is lacked or deficient. The filling material process can be done by using the printing machine, stamping machine, or laser chemical vapor deposition (laser CVD) machine, and the like.

Several embodiments are listed below to elucidate the applications of the present invention to various products.

(I) The Defect Detection, Inspection and Repairing of the Color Filters for the Liquid Crystal Display (LCD)

The production process of the color filters is one of the whole production processes of LCD, and includes the repeated coatings of red, green and blue color filter films on the glass substrate. When each coating is finished, the glass substrate is sent to the automated optical defect detection system to detect the defects. At first, the defects are detected, and the defect location information is recorded in the database. The defect inspection device generates the shortest path based on the defect location information, moves along the shortest path, and takes a picture for each defect. These defect images can be used for the analyses of the causes of the defects by the officials in the Quality Assurance Department to improve the production processes.

The defect repairing machine can be used to repair the defects, if it is required. The defect repairing machine contains a defect repairing device and an image capturing device. The defect repairing device can move along the above shortest path to repair the defects. The processes are described below. The defect repairing device acquires the above path information from the database. The technician can use the image capturing device to capture the instant image of the defect and to repair the defect manually, e.g. to fill the light-leaking defect with the make-up lotion. After the defect is repaired, the defect repairing device will move to the next defect according to the shortest path and repeat the repairing actions until all the defects are repaired.

(II) The Defect Detection, Inspection and Repairing of the Thin Film Transistor Arrays for the Liquid Crystal Display (LCD)

These array processes are ones of the whole production processes of LCD, and include the repeated the photolithography processes of photo-resist coating, photo exposure and etching (photo engraving) in order to form the electrical circuits on the glass substrate to drive the liquid crystals.

When each set of the photolithography processes is completed, the glass substrate is sent to the automated optical defect detection system to detect the defects. At first, the defects are detected, and the defect location information is recorded in the database.

The defect inspection machine generates the shortest path based on the defect location information. The defect inspection device moves along the shortest path, and takes a picture for each defect. These defect images can be used for the analyses of the causes of the defects by the officials in the Quality Assurance Department to improve the production processes.

The defect repairing machine includes a movable repairing device and a movable image capturing device. The processes are described below. The defect repairing device acquires the above path information from the database. The technician can use the image capturing device to capture the instant image of the defect and to repair the defect manually. If the defect is caused by a stain or a short circuit, the laser repairing technique can be used. If the defect is caused by the broken circuit, the laser CVD technique can be used. After the defect is repaired, the defect repairing device will move to the next defect according to the shortest path and repeat the repairing actions until all the defects are repaired.

(III) The Defect Detection, Inspection and Repairing of the Mercury Free Flat Fluorescent Lamp (FFL)

The printed electrode circuits on the glass plate are detected. This glass plate is back plate of the mercury free flat FFL. The electrode circuits have the function of exciting the particular gaseous molecules to generate the voltage difference and the consequent ultraviolet light, which irradiates on the fluorescent powders coated in the FFL to generate the visible light.

The automated optical defect detection system can detect the defects on the above glass plate, and store the information about the locations, types and dimensions of the defects into a database.

The defect inspection machine generates the shortest path based on the defect location information. The image capturing device on the defect inspection machine moves along the shortest path, and takes a picture for each defect by using the image capturing device. These defect images can be used for the analyses of the causes of the defects by the officials in the Quality Assurance Department to improve the production processes.

The defect repairing machine includes a movable repairing device and a movable image capturing device. The processes are described below. The defect repairing machine acquires the above path information from the database. The technician can use the image capturing device to capture the instant image of the defect and to repair the defect manually. If the defect is caused by the broken circuit, the dent or the pin hole, the material will be filled into these defects. If the defect is caused by a stain or a lump, the redundant or undesired materials will be cleared off. After the defect is repaired, the defect repairing device will move to the next defect according to the shortest path and repeat the repairing actions until all the defects are repaired.

As the above-mentioned, the target of the present invention is to speed up the production processes of the products with fine structures on the plates. After the investigation, research and experiments, the methods to speed up the processes for the automated optical defect detection, inspection and repairing are developed. By using the numerical operation models to obtain the shortest path for going through all the defects, the devices can finish the defect detection, inspection and repairing for all the defects according to the shortest path with the great reduction in the processing time. Accordingly, the production yield and throughput are significantly raised. Moreover, since the moving distances for the related machines are greatly shortened, consequently the machine wearing and aging are largely reduced, and the lifetimes of the machines are significantly extended. In a conclusion, the present invention can greatly raise the production throughput and reduce the machine maintenance cost with various advantages.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A path mapping method after an optical defect detection, comprising steps of:
providing an article;
detecting at least two defects on the article;
providing a numerical operation model; and
obtaining a mapped path for connecting the at least two defects by using the numerical operation model.

2. A path mapping method according to claim 1, wherein the mapped path is one of a shortest path and a preferable path for connecting the at least two defects.

3. A path mapping method according to claim 1, wherein the at least two defects are detected by scanning the article by using an optical detection machine.

4. A path mapping method according to claim 1, further comprising a step of providing the mapped path for an operation of one of a defect inspection machine, a defect repairing machine and a combination thereof, wherein the mapped path is an open path with two ends, and the one of the defect inspection machine, the defect repairing machine and the combination thereof operates along the open path by starting at one of the two ends.

5. A path mapping method according to claim 4, wherein the starting end is a nearer end to the one of the defect inspection machine, the defect repairing machine and the combination thereof.

6. A path mapping method according to claim 4, wherein the defect inspection machine comprises a photosensitive unit being one of a charge coupled device and a complementary metal-oxide semiconductor.

7. A path mapping method according to claim 1, further comprising a step of storing data of the at least two defects and the mapped path in a database.

8. A path mapping method according to claim 1, wherein the numerical operation model is one selected from a group consisting of a brute force method, a cutting plane method, a Markov chain method, a nearest neighborhood method, a generic algorithm and an ant colony optimization algorithm.

9. A path mapping method after an optical defect detection, wherein at least two defects on an article are detected after scanning the article by using an optical detection machine, comprising steps of:
generating at least one sequence of the at least two defects;
obtaining at least one path for connecting the at least two defects according to the at least one sequence;
comparing the at least one path; and
choosing a desired path from the at least one path.

10. A path mapping method according to claim 9, wherein the desired path is a shortest path among the at least one path.

11. A path mapping method according to claim 9, wherein the desired path is provided for an operation of one of a defect inspection machine, a defect repairing machine and a combination thereof.

12. A path mapping method according to claim 11, wherein the desired path is an open path with two ends, and the one of the defect inspection machine, the defect repairing machine and the combination thereof operates along the open path by starting at one of the two ends.

13. A path mapping method after a defect detection, comprising a step of determining a mapped path for connecting a plurality of defects by using a numerical operation model.

14. A path mapping method according to claim 13, wherein the mapped path is one of a shortest path and a preferable path for connecting the plurality of defects.

15. A path mapping method according to claim 13, further comprising a step of providing the mapped path for an operation of one of a defect inspection machine, a defect repairing machine and a combination thereof.

16. A path mapping method according to claim 15, wherein the mapped path is an open path with two ends, and the one of the defect inspection machine, the defect repairing machine and the combination thereof operates along the open path by starting at one of the two ends.

17. A path mapping method according to claim 16, wherein the starting end is a nearer end to the one of the defect inspection machine, the defect repairing machine and the combination thereof.

18. A path mapping method according to claim 15, where in the defect inspection machine comprises a photosensitive unit being one of a charge coupled device and a complementary metal-oxide semiconductor.

19. A path mapping method according to claim 13, further comprising a step of storing data of the plurality of defects and the mapped path in a database.

20. A path mapping method according to claim 13, wherein the numerical operation model is one selected from a group consisting of a brute force method, a cutting plane method, a Markov chain method, a nearest neighborhood method, a generic algorithm and an ant colony optimization algorithm.
